(19) United States
(12) Patent Application Publication
(10) Pub. No.: US 2006/0275697 A1
(43) Pub. Date: Dec. 7, 2006

(54) Top coating composition for photoresist and method of forming photoresist pattern using the same

(76) Inventors: Mitsuhiro Hata, Gyeonggi-do (KR); Man-Hyoung Ryoo, Gyeonggi-do (KR); Hyun-Woo Kim, Gyeonggi-do (KR); Sang-Gyun Woo, Gyeonggi-do (KR); Jin-Young Yoon, Seoul (KR); Jung-Hwan Hah, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/364,707

(22) Filed: Feb. 27, 2006

(30) Foreign Application Priority Data
Jun. 4, 2005 (KR) 2005-48111

(51) Int. Cl. G03C 1/00

(52) U.S. Cl. 430/270.1

(57) ABSTRACT

Provided are a top coating composition for a photoresist which can be used in immersion lithography, and a method of forming a photoresist pattern using the same. The top coating composition includes: a polymer including at least three different structural repeating units including a first repeating unit comprising a carboxy group substituted by an alkyl protecting group or an acid-labile group, a second repeating unit comprising an acid group, and a third repeating unit comprising a polar group, and an organic solvent comprising an alcohol.

### CROSS-REFERENCE TO RELATED PATENT APPLICATION

This application claims the benefit of Korean Patent Application No. 10-2005-0048111, filed on Jun. 4, 2005, in the Korean Intellectual Property Office, the disclosure of which is incorporated herein in its entirety by reference.

### BACKGROUND OF THE INVENTION

1. Field of the Invention

The present invention relates to a top coating composition for a photoresist and a method of forming a photoresist pattern using the same, and more particularly, to a top coating composition for a photoresist used to manufacture a semiconductor integrated circuit which can be used in immersion lithography, and a method of forming a photoresist pattern using the same.

2. Description of the Related Art

In order to improve the performance of a system, immersion lithography is performed when a gab between a final lens and a wafer in an optic box is completely filled with a liquid. An immersion lithography technique initially developed is disclosed in, for example, U.S. Pat. No. 4,346,164.

In a lithography process, the numeral aperture (NA) is given by
NA=n Sin α
where n is the refractive index of an immersion medium and a is the angle between the optical axis of the system and light that enters into an object lens farthest from the optical axis. That is, when the NA is large and a light source has a shorter wavelength, a good resolution can be obtained. Since an immersion medium is used in immersion lithography, NA>1, specifically NA≧1.3 or 1.4, and thus, the resolution is increased. In particular, when H₂O is used as the immersion medium, a better resolution and depth of focus (DOF) than in conventional lithography can be attained because n is 1.44 for H₂O.

However, the use of H₂O as a liquid medium results in several problems. For example, photoresist components such as a photoacid generator (PAG) or a base may leach into water. In order to solve this problem, a top barrier coating can be used on a photoresist, which is disclosed, for example, by R. R. Dammel, F. M. Houlihan, R. Sakamuri, D. Rentkiewics, and A. Romano in J. Photopol. Sci. Tech., 587, 4 (2004). In this case, the immersion medium does not directly contact the photoresist, thus preventing the leaching of the photoresist components.

A top barrier coating composition for immersion lithography must be water-insoluble during exposure, have low absorbance at the wavelength of an exposure light source, be soluble in a developing solution after exposure, and must not intermix with a photoresist. Several top barrier coating compositions that satisfy these requirements have been suggested, for example, by M. Yoshida, K. Endo, K. Ishizuka, and M. Sato in J. Photopol. Sci. Tech., 603, 4 (2004). However, the suggested top barrier coating compositions have inferior solubility to an alkaline developing solution, thereby generating defects during development.

### SUMMARY OF THE INVENTION

The present invention provides a top coating composition which is water-insoluble such that photoresist components do not dissolve in water, does not intermix with a photoresist when coated on the surface of the photoresist, has low absorbance to an exposure light source during exposure, and is easily soluble in a developing solution after exposure in an immersion lithography process.

The present invention also provides a method of forming a photoresist pattern suitable for an immersion lithography process, which enhances resolution and depth of focus (DOF) to provide micro-patterns having good pattern profiles.

According to an aspect of the present invention, a top coating composition is provided comprising a polymer including at least three different structural repeating units including a first repeating unit comprising a carboxy group substituted by an alkyl protecting group or an acid-labile group, a second repeating unit comprising an acid group, and a third repeating unit comprising a polar group, and an organic solvent comprising an alcohol. Preferably, the first repeating unit comprises the following structural formula:

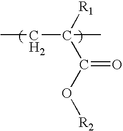

where R₁ is hydrogen, fluorine, methyl, or trifluoromethyl; and R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl.

Also, it is preferred that the acid group in the second repeating unit is a carboxy group or a sulfonic group. More preferably, the second repeating unit is a monomer unit selected from the group consisting of acrylate, methacrylate, α-fluoroacrylate, trifluoromethyl acrylate, vinyl sulfonic acid, styrene sulfonic acid, maleate, and crotonic acid. Preferably, the polar group in the third repeating unit is an acid group or an alcohol group. More preferably, the third repeating unit is 2-hydroxyethyl acrylate, 2-hydroxyethyl methacrylate, 3-hydroxypropyl acrylate, 2-hydroxypropyl acrylate, 3-hydroxypropyl methacrylate, 2-hydroxypropyl methacrylate, 2-hydroxyethyl α-fluoroacrylate, 2-hydroxyethyl trifluoromethylacrylate, 3-hydroxypropyl α-fluoroacrylate, 2-hydroxypropyl α-fluoroacrylate, 3-hydroxypropyl trifluoromethylacrylate, 2-hydroxypropyl trifluoromethylacrylate, α,α-bis-(trifluorometyl)-bicyclo[2.2.1]hept-5-ene-ethanol, 5-[1′,1′,1′-trifluoro-2′-trifluorometyl-2′-hydroxy)propyl]norbornan-2-yl vinyl ether, 6-[3,3,3-trifluoro-2-hydroxy-2-trifluoromethylpropyl]bicyclo[2.2.1]hept-2-yl 2-trifluoromethylacrylate, 3,5-bis(hexafluoro-2-hydroxy-2-propyl)cyclohexyl 2-trifluoromethylacrylate, or 3,5-bis(hexafluoro-2-hydroxy-2-propyl)cyclohexyl vinyl ether.

Preferably, the polymer further includes a fourth repeating unit comprising fluorine. More preferably, the fourth repeating unit is tetrafluoroethylene, α,α,α-trifluroethyl acrylic acid, α,α,α-trifluroethyl methacrylic acid, α,α,α-trifluroethyl α-fluoroacrylic acid, or α,α,α-trifluroethyl trifluoromethylacrylic acid. In another embodiment, the fourth repeating unit further comprises a polar group. More preferably, when the fourth repeating unit is a polar group it comprises the following structural formula:

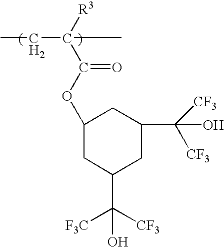

where R₃ is hydrogen or a methyl group.

The polymer preferably comprises the following structural formula:

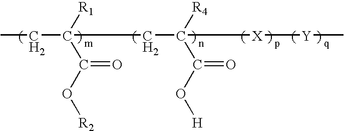

where m+n+p+q=1; 0.03≦m/(m+n+p+q)≦0.97; 0.03≦(n+p)/(m+n+p+q)≦0.97; 0≦q/(m+n+p+q)≦0.5; R₁ is hydrogen, fluorine, methyl, or trifluoromethyl; R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-y-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl; R₄ is hydrogen, fluorine, methyl, or trifluoromethyl; X is a polar group; and Y is a monomer unit selected from the group consisting of a vinyl type monomer, an alkylene glycol type monomer, an anhydrous maleate monomer, an ethyleneimine monomer, a monomer including an oxazoline group, an acrylonitirle monomer, an allyl amide monomer, a 3,4-dihydropyran monomer, a 2,3-dihydrofuran monomer, a tetrafluoroethylene monomer, an α,α,α-trifluroethyl acrylic acid monomer, an α,α,α-trifluroethyl methacrylic acid monomer, an α,α,α-trifluroethyl α-fluoroacrylic acid monomer, and an α,α,α-trifluroethyl trifluoromethylacrylic acid monomer. More preferably, the polymer comprises a weight average molecular weight (Mw) of from about 1,000 up to 100,000 daltons. Moreover, the amount of the polymer can preferably be from about 0.1 up to 5.0% by weight, based on the total weight of the top coating composition.

The organic solvent is preferably selected from the group consisting of ethanol, n-propylalcohol, isopropyl alcohol, 1-methoxy-2-propanol, n-butanol, 2-butanol, 3-methyl-2-butanol, n-pentanol, 2-pentanol, 3-methyl-2-pentanol, and 4-methyl-2-pentanol, or a combination thereof.

The top coating can further comprise a thermal acid generator (TAG). The amount of the TAG is preferably from about 0.05 up to 0.3% by weight, based on the total weight of the top coating composition.

The top coating composition can further comprise a surfactant. The amount of the surfactant is preferably from about 0.001 up to 0.01% by weight, based on the total weight of the top coating composition.

The top coating composition can further comprise a fluorinated compound. The fluorinated compound is preferably at least one of tetramethylammonium trifluoroacetate, tetramethylammonium pentafluoropropionate, tetramethylammonium heptafluorobutyrate, tetramethylammonium nonafluorovalerate, tetramethylammonium undecafluorohexanate, tetramethylammonium tridecafluoroheptanate, tetramethylammonium pentadecafluorooctanate, tetramethylammonium heptadecafluorononanate, tetramethylammonium nonadecafluorodecanate, tetramethylammonium perfluoroundecanate, tetramethylammonium tricosafluorododecanate, tetramethylammonium perfluorotetradecanate, tetramethylammonium heptadecafluorooctanesulfonate, and tetramethylammonium nonafluorobutane-1-sulfonate. The amount of the fluorinated compound is preferably from about 0.01 up to 0.3% by weight based on the total weight of the top coating composition.

A method of forming a photoresist pattern is also provided. The method comprises forming a photoresist layer on a substrate, and soft-baking the photoresist layer at a first temperature, thereby forming a top coating layer on the soft-baked photoresist layer. The top coating comprises an organic solvent comprising an alcohol and a polymer including at least three different structural repeating units, wherein a first repeating unit comprises a carboxy group substituted by one of an alkyl protecting group and an acid-labile group, a second repeating unit comprising an acid group, and a third repeating unit comprising a polar group.

Then, a predetermined region of the photoresist layer is exposed through the liquid medium when the top coating layer covers the photoresist layer, the exposed photoresist layer is post-exposure baked, the top coating layer is removed, and the exposed photoresist layer is developed. Preferably, the forming of the top coating layer comprises spin-coating a top coating composition on the photoresist layer, and then heat-treating the spin-coated top coating composition. Preferably, the spin-coating is performed at from about 500 up to 3000 rpm for from about 30 up to 90 seconds. In another embodiment, the heat treatment is performed at a temperature between of from about 95 up to 105° C. Preferably, the removing of the top coating layer and the developing of the exposed photoresist layer are performed at the same time, and more preferably, an alkaline developing solution is used for the removing of the top coating layer and for developing of the exposed photoresist layer. In a further embodiment, in the exposing of the predetermined region in the photoresist layer, a light source selected from a KrF excimer laser, an ArF excimer laser, and a F₂ excimer laser is used. And in still another embodiment, the photoresist layer comprises a positive resist composition or a negative resist composition.

According to an embodiment of the present invention, a water-insoluble top coating layer obtained from a composition having an alcoholic organic solvent is used as a barrier during immersion lithography such that photoresist components are prevented from dissolving in the liquid medium during exposure through the liquid medium and from the intermixing with the photoresist during photolithography. In addition, according to an embodiment of the present invention, the top coating composition can be formed into a top coating barrier which has low absorbance to an exposure light source during exposure, and is easily soluble in a developing solution after exposure in an immersion lithography process. A photoresist pattern is formed using the top coating composition according to an embodiment of the present invention in immersion lithography, thereby obtaining a pattern which can provide enhanced resolution and depth of focus (DOF).

### BRIEF DESCRIPTION OF THE DRAWINGS

The above and other features and advantages of the present invention will become more apparent by describing in detail exemplary embodiments thereof with reference to the attached drawings in which:

FIGS. 1A through 1E are sectional views for illustrating a method of forming a photoresist pattern according to an embodiment of the present invention;

FIG. 2A is a scanning electron microscopy (SEM) image showing a top profile of a line and space pattern obtained by immersion lithography using a top coating composition having polymers synthesized according to an embodiment of the present invention;

FIG. 2B is a SEM image showing a vertical profile of the line and space pattern of FIG. 2A;

FIG. 3A is a SEM image showing a top profile of a line and space pattern obtained by immersion lithography using a top coating composition having polymers synthesized according to another embodiment of the present invention;

FIG. 3B is a SEM image showing a vertical profile of the line and space pattern of FIG. 3A;

FIG. 4A is a SEM image showing a top profile of a line and space pattern obtained by immersion lithography using a top coating composition having polymers synthesized according to still another embodiment of the present invention;

FIG. 4B is a SEM image showing a vertical profile of the line and space pattern of FIG. 4A;

FIG. 5A is a SEM image showing a top profile of a line and space pattern obtained by immersion lithography using a top coating composition having a thermal acid generator (TAG) and polymers synthesized according to yet another embodiment of the present invention; and

FIG. 5B is a SEM image showing a vertical profile of the line and space pattern of FIG. 5A.

### DETAILED DESCRIPTION

A top coating composition according to an embodiment of the present invention may be used to form on a photoresist a top barrier coating layer which prevents leaching of photoresist components from the photoresist layer during an exposing process of immersion lithography. The top coating composition composes the top barrier coating layer acting as a top barrier. A top coating composition according to an embodiment of the present invention includes a polymer including at least three different structural repeating units, which are a first repeating unit having a carboxy group substituted by an alkyl protecting group or an acid-labile group, a second repeating unit having an acid group, and a third repeating unit having a polar group, and an alcoholic organic solvent.

The polymer in the top coating composition may further include a fourth repeating unit having fluorine, if desired. The fourth repeating unit may include the fluorine and a polar group.

The top coating composition may further include a potential acid, such as a thermal acid generator (TAG). The potential acid produces an acid only under specific conditions.

The top coating composition may further include at least an additive selected from a surfactant and a fluorinated compound.

The top coating composition according to an embodiment of the present invention will now be described in detail.

Polymer

A top coating composition according to an embodiment of the present invention includes a polymer including at least three different structural repeating units, which are a first repeating unit having a carboxy group substituted by an alkyl protecting group or an acid-labile group, a second repeating unit having an acid group, and a third repeating unit having a polar group.

The first repeating unit is employed for enhancing barrier characteristics of the top coating layer formed on the surface of the top coating layer using the top coating composition, and for increasing the solubility of the top coating layer with respect to a developing solution. The polymer has hydrophobicity due to an alkyl protecting group or an acid-labile protecting group in the first repeating unit, thereby increasing the barrier characteristics of the top coating layer covering the photoresist layer during immersion lithography.

The first repeating unit may be expressed by the following formula:

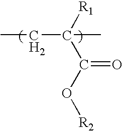

where R₁ may be one selected from hydrogen, fluorine, methyl, and trifluoromethyl; and R₂ may be a C₁ to C₁₀ alkyl group, such as t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, and ethoxymethyl.

The second repeating unit is employed for increasing the solubility of the top coating layer with respect to a developing solution. An acid group in the second repeating unit may be one of a carboxy group and a sulfonic group.

The second repeating unit may be a one monomer unit selected from an acrylate, methacrylate, α-fluoroacrylate, trifluoromethyl acrylate, vinyl sulfonic acid, styrene sulfonic acid, maleate, and crotonic acid.

The third repeating unit is employed for increasing the solubility of the top coating layer to an alcoholic organic solvent. A polar group in the third repeating unit may be one of an acid group and an alcohol group.

The third repeating unit may preferably be selected from the group consisting of 2-hydroxyethyl acrylate, 2-hydroxyethyl methacrylate, 3-hydroxypropyl acrylate, 2-hydroxypropyl acrylate, 3-hydroxypropyl methacrylate, 2-hydroxypropyl methacrylate, 2-hydroxyethyl α-fluoroacrylate, 2-hydroxyethyl trifluoromethylacrylate, 3-hydroxypropyl α-fluoroacrylate, 2-hydroxypropyl α-fluoroacrylate, 3-hydroxypropyl trifluoromethylacrylate, 2-hydroxypropyl trifluoromethylacrylate, α,α-bis-(trifluorometyl)-bicyclo[2.2.1]hept-5-ene-ethanol, 5-[1′,1′,1′-trifluoro-2′-trifluorometyl-2′-hydroxy)propyl]norbornan-2-yl vinyl ether, 6-[3,3,3-trifluoro-2-hydroxy-2-trifluoromethylpropyl]bicyclo[2.2.1]hept-2-yl 2-trifluoromethylacrylate, 3,5-bis(hexafluoro-2-hydroxy-2-propyl)cyclohexyl 2-trifluoromethylacrylate, and 3,5-bis(hexafluoro-2-hydroxy-2-propyl)cyclohexyl vinyl ether.

The polymer may further comprise a fourth repeating unit including fluorine. The fourth repeating unit is employed for enhancing transmittance and controlling the hydrophobicity of the polymer when exposing with a light source of an ArF excimer laser with a wavelength of 193 nm. Accordingly, the amount of the fourth repeating unit varies according to desired polymer characteristics.

For example, the fourth repeating unit may be a monomeric unit selected from the group consisting of tetrafluoroethylene, α,α,α-trifluroethyl acrylic acid, α,α,α-trifluroethyl methacrylic acid, α,α,α-trifluroethyl α-fluoroacrylic acid, and α,α,α-trifluroethyl trifluoromethylacrylic acid.

A monomeric unit having fluorine and a polar group, for example, a monomer unit expressed by the following formula, can be used as the fourth repeating unit.

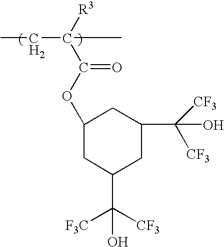

where R₃ is one of hydrogen and a methyl group.

The polymer included in the top coating composition may be expressed by the following formula.

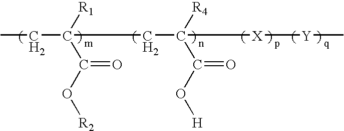

where m+n+p+q=1; 0.03≦m/(m+n+p+q)≦0.97; 0.03≦(n+p)/(m+n+p+q)≦0.97; and 0≦q/(m+n+p+q)≦0.5. R₁ and R₂ are the same as the above definition. R₄ is one of hydrogen, fluorine, methyl, trifluoromethyl, X is the third repeating unit, and Y may be one monomer unit selected from the group consisting of a vinyl type monomer, an alkylene glycol type monomer, an anhydrous maleate monomer, an ethyleneimine monomer, a monomer including an oxazoline group, an acrylonitirle monomer, an allyl amide monomer, a 3,4-dihydropyran monomer, a 2,3-dihydrofuran monomer, a tetrafluoroethylene monomer, an α,α,α-trifluroethyl acrylic acid monomer, an α,α,α-trifluroethyl methacrylic acid monomer, an α,α,α-trifluroethyl α-fluoroacrylic acid monomer, and an α,α,α-trifluroethyl trifluoromethylacrylic acid monomer.

The polymer forming the top coating composition according to an embodiment of the present invention may have a preferred weight average molecular weight (Mw) of 1,000 to 100,000 daltons, more preferably, 2,000 to 50,000 daltons. The concentration of the polymer may be in the preferred range of 0.1 to 5.0% by weight, more preferably, 0.5 to 1.0% by weight based on the total weight of the top coating composition.

Potential Acid

A potential acid may preferably be contained in the top coating composition may include a TAG. Examples of the TAG can include currently available KUNHO TAG lot #020114 (obtained from KUMHO ASAN Lab.) and 1-p-toluenesulfonate-2-hydroxycyclohexane.

The concentration of the TAG may be in the preferred range of 0.05 to 0.3% by weight, more preferably, 0.08 to 0.2% by weight, based on the total weight of the top coating composition.

The potential acid is employed for increasing the solubility of the top coating layer, which is formed on the surface of the top coating layer using the top coating composition, to a developing solution.

Surfactant

A surfactant may preferably be contained in the top coating composition is used to uniformly coat the top coating composition. Various surfactants, such as Fluorad™ (obtained from 3M), NONIPORU™ (obtained from SANYOKASEI), MEGAFACE™ (obtained from Dainippon Ink & Chemicals), and Zonyl-FSN (obtained from DuPont), are used solely or in combination. The concentration of the surfactant may be in the preferred range of 0.001 to 0.01% by weight, based on the total weight of the top coating composition.

Fluorinated Compound

A fluorinated compound which is preferably contained in the top coating composition can be used to increase the transmittance of a top coating layer formed from the top coating composition according to an embodiment of the present invention, specifically when the coating layer is exposed to an ArF excimer laser with a wavelength of 193 nm. The fluorinated compound may more preferably be at least one compound selected from the group consisting of tetramethylammonium trifluoroacetate, tetramethylammonium pentafluoropropionate, tetramethylammonium heptafluorobutyrate, tetramethylammonium nonafluorovalerate, tetramethylammonium undecafluorohexanate, tetramethylammonium tridecafluoroheptanate, tetramethylammonium pentadecafluorooctanate, tetramethylammonium heptadecafluorononanate, tetramethylammonium nonadecafluorodecanate, tetramethylammonium perfluoroundecanate, tetramethylammonium tricosafluorododecanate, tetramethylammonium perfluorotetradecanate, tetramethylammonium heptadecafluorooctanesulfonate, and tetramethylammonium nonafluorobutane-1-sulfonate.

The concentration of the fluorinated compound may be in the preferred range of 0.01 to 0.3% by weight, based on the total compound of the top coating composition.

Solvent

The solvent can preferably comprise an alcoholic organic solvent. The alcoholic organic solvent may more preferably be one selected from the group consisting of ethanol, n-propylalcohol, isopropyl alcohol, 1-methoxy-2-propanol, n-butanol, 2-butanol, 3-methyl-2-butanol, n-pentanol, 2-pentanol, 3-methyl-2-pentanol, and 4-methyl-2-pentanol, and a combination thereof. However, this does not limit the scope of the present invention. Although not exemplified, it is well known to those skilled in the art that various alcoholic organic solvents can be used to obtain the top coating composition according to an embodiment of the present invention.

A predetermined amount of alkane, nitryl, or ether can preferably be mixed with the alcoholic organic solvent, if desired.

Methods of forming a photoresist pattern according to embodiments of the present include an immersion lithography process. In these methods, a photoresist layer is coated with the top coating composition according to an embodiment of the present invention to form a top coating layer acting as a top barrier so that the leaching of photoresist components into a liquid medium, such as water, can be prevented.

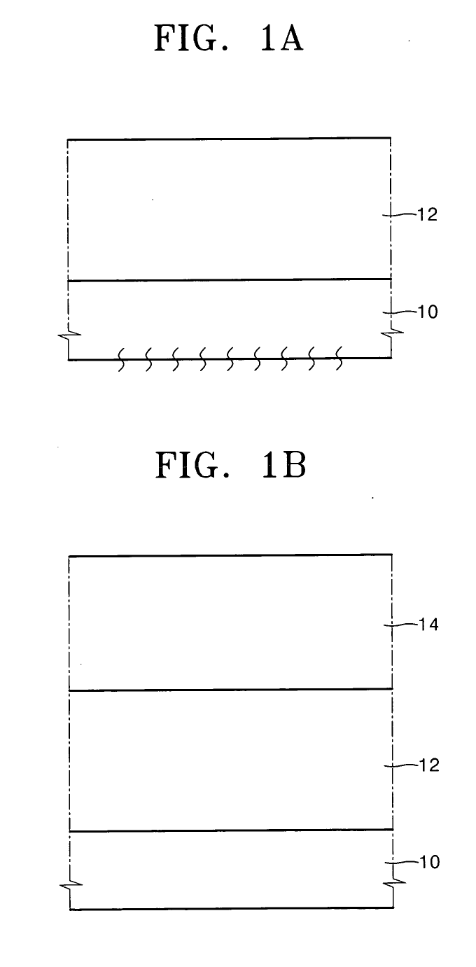

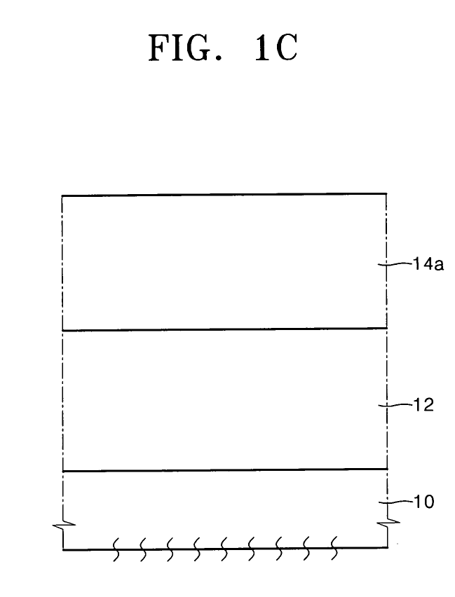

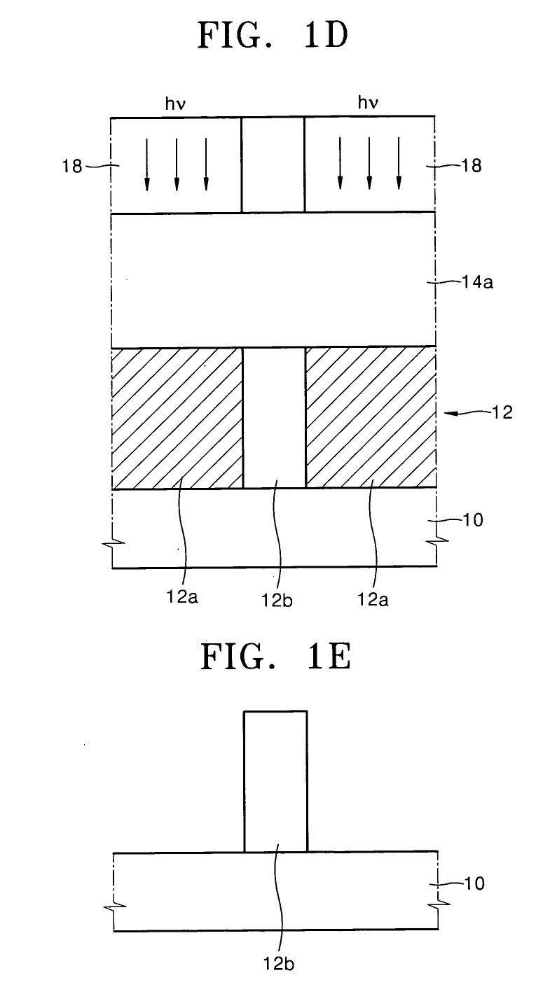

FIGS. 1A through 1E are sectional views for illustrating a method of forming a photoresist pattern according to an embodiment of the present invention.

Referring to FIG. 1A, a photoresist layer 12 is formed on a semiconductor substrate 10 on which a predetermined layer to be etched (not shown) is formed. The photoresist layer 12 may be formed of a conventional chemically amplified resist composition containing a photo acid generator (PAG). The chemically amplified resist composition may be a resist composition for a KrF excimer laser (248 nm), an ArF excimer laser (193 nm), or a F₂ excimer laser (157 nm). In addition, the photoresist layer 12 may be formed of a positive resist composition or a negative resist composition.

The photoresist layer 12 formed on the semiconductor substrate 10 is softly baked at a temperature of about 105 to 130° C.

Referring to FIG. 1B, the photoresist layer 12 is spin-coated with the top coating composition according to an embodiment of the present invention, thus forming a top coating composition layer 14. The spin-coating may be preferably performed at 500 to 3000 rpm for 30 to 90 second to form the top coating composition layer 14. The spin-coating may be more preferably performed at 1500 to 2000 rpm for 30 to 90 seconds to more defect-freely and uniformly form the top coating composition layer 14.

Referring to FIG. 1C, the semiconductor substrate 10 having the top coating composition layer 14 is heat-treated to form a water-insoluble top coating layer 14a. The heat treatment is performed at a preferred temperature between about 95 to 105° C.

Referring to FIG. 1D, a predetermined portion of the photoresist layer 12 coated with the water-insoluble coating layer 14a is exposed via a liquid medium 18 to a light source selected from a KrF excimer laser (248 nm), an ArF excimer laser (193 nm), and a F₂ excimer laser (157 nm). After the exposure, the photoresist layer 12 is divided into an exposed region 12a and a non-exposed region 12b.

The liquid medium 18 may include, for example, water. In this case, the water-insoluble top coating layer 14a interposed between the photoresist layer 12 and the liquid medium 18 acts as a barrier that prevent photoresist components of the photoresist layer 12 from undesirably leaching into the liquid medium 18.

Referring to FIG. 1E, after the exposure via the liquid medium 18 is completed, the exposed photoresist layer 12 is subjected to post-exposure baking (PEB). Then, the water-insoluble top coating layer 14a is removed and the exposed photoresist layer 12 is developed. The water-insoluble top coating layer 14a made of the top coating composition according to an embodiment of the present invention has good solubility to an alkaline developing solution. Accordingly, it is unnecessary to perform a process for removing the water-insoluble top coating layer 14a, but the water-insoluble top coating layer 14a can be completely simultaneously removed by the developing solution when developing the exposed photoresist layer 12. The alkaline developing solution may be, for example, a 2.38% tetramethylamonium hydroxide solution for the development of the photoresist layer 12.

After the developing process is completed, the water-insoluble top coating layer 14a and an exposed region 12a of the photoresist layer 12 are removed, and then a photoresist pattern is formed from the photoresist layer 12 on the semiconductor substrate 10. When the photoresist layer 12 includes a positive resist composition, only the non-exposed region 12b remains on the semiconductor substrate 10, as illustrated in FIG. 1E. In this case, the photoresist pattern is formed of the non-exposed region 12b. However this does not limit the scope of the present invention. When the photoresist layer 12 includes a negative resist composition, which is not illustrated, only the exposed region 12a remains on the semiconductor substrate 10 when forming the photoresist pattern.

Hereinafter, the present invention will be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

### EXAMPLE 1

### EXAMPLE 1-1

### Barrier Characteristics of Top Coating Layer with Respect to Deionized Water

A methoxy-2-propanol solution, in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:9 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.322 Å/sec. The wafer was developed with a 2.38% by weight of a tetramethylammonium hydroxide solution. As a result, the top coating layer was partially removed.

### EXAMPLE 1-2

### Barrier Characteristics in Immersion Lithography Process using Top Coating Layer

A photoresist pattern was formed using an immersion lithography process and a top coating layer including a top coating composition according to an embodiment of the present invention. Barrier characteristics of the top coating layer were measured. In this case, during the exposure, mimic immersion lithography was performed instead of exposure via a liquid medium. That is, the subject to be exposed was immersed in deionized water for 60 seconds, dry-exposed, and then immersed in deionized water for 60 seconds. Hereinafter, the process conditions of the mimic immersion lithography of the current example are equally applied to other examples unless other specific conditions therefor are provided.

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:9 was dissolved, was spin-coated onto the wafer to form a layer of a uniform thickness and, was heat-treated at about 100° C. for about 90 seconds to form a top coating layer. The resultant product was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 2

### EXAMPLE 2-1

### Barrier Characteristics of Top Coating Layer with Respect to Deionized Water

An n-butanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 4:1:9 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.098 Å/sec. The wafer was developed with a 2.38% by weight of a tetramethylammonium hydroxide solution. As a result, the top coating layer was completely removed.

### EXAMPLE 2-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 4:1:9 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 3

### Barrier Characteristics of Top Coating Layer with Respect to Deionized Water

An 1-methoxy-2-propanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 3:1:9 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.292 Å/sec. The wafer was developed with a 2.38% by weight of a tetramethylammonium hydroxide solution. As a result, the top coating layer was completely removed.

### EXAMPLE 4

### Barrier Characteristics of Top Coating Layer with Respect to Deionized Water

An 1-butanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 4:1:5 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.044 Å/sec. The wafer was developed with a 2.38% by weight of a tetramethylammonium hydroxide solution. As a result, the top coating layer was partially removed.

### EXAMPLE 5

### Barrier Characteristics of Top Coating Layer with Respect to Deionized Water

An 1-ethanol solution, in which an 1% by weight of poly(2-tetrahydropyranyl methacrylate-co-methacrylic acid-co-2-hydroxyethyl methacrylate) obtained by mixing and polymerizing 2-tetrahydropyranyl methacrylate, methacrylic acid, and 2-hydroxyethyl methacrylate with a mole ratio of 3:8:2 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.0 Å/sec. The wafer was developed with a 2.38% by weight of a tetramethylammonium hydroxide solution. As a result, the top coating layer was completely removed.

### EXAMPLE 6

### EXAMPLE 6-1

### Barrier Characteristics of Top Coating Layer with Respect to Deionized Water

An n-butanol solution, in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:6 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.104 Å/sec. The wafer was developed with a 2.38% by weight of a tetramethylammonium hydroxide solution. As a result, the top coating layer was partially removed.

### EXAMPLE 6-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:6 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 7

### EXAMPLE 7-1

### Barrier Characteristics of Top Coating Layer with Respect to Deionized Water

An n-butanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 8:5:3 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.0 Å/sec. The wafer was developed with a 2.38% by weight of a tetramethylammonium hydroxide solution. As a result, the top coating layer was partially removed.

### EXAMPLE 7-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 8:5:3 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 8

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 8:3:5 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 9

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-acrylic acid-co-3-hydroxypropyl acrylate) obtained by mixing and polymerizing 2-ethyl-2-adamantyl acrylate, acrylic acid, and 3-hydroxypropyl acrylate with a mole ratio of 8:1:8 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 10

### EXAMPLE 10-1

### Barrier Characteristics of Top Coating Layer with Respect to Deionized Water

An n-butanol solution, in which an 1% by weight of poly(2-ethyl-2-adamantyl acrylate-co-acrylic acid) obtained by mixing and polymerizing 2-ethyl-2-adamantyl acrylate and acrylic acid with a mole ratio of 4:3 was dissolved, was spin-coated onto an 8-inch bare-silicon wafer, and was heat-treated at about 100° C. for about 60 seconds to form a top coating layer. Then, the wafer on which the top coating layer was formed was rinsed with deionized water for about 90 seconds. At this time, the dissolution rate of the top coating layer was about 0.0 Å/sec. The wafer was developed with a 2.38% by weight of a tetramethylammonium hydroxide solution. As a result, the top coating layer was partially removed.

### EXAMPLE 10-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

An isopropanol solution, in which an 1% by weight of poly(2-ethyl-2-adamantyl acrylate-co-acrylic acid) obtained by mixing and polymerizing 2-ethyl-2-adamantyl acrylate and acrylic acid with a mole ratio of 4:3 was dissolved, was spin-coated onto the wafer to form a layer of a uniform thickness and, was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 180 nm were obtained.

### EXAMPLE 11

### EXAMPLE 11-1

### Manufacture of Top Coating Composition for Immersion Lithography Process

50 mg of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:4 and 2.5 mg of TAG (KUMHO TAG lot#020114 obtained from KUMHO ASAN Lab.) are dissolved in 4.95 g of an isopropanol solution, and then the solution was filtrated to obtain a top coating composition.

### EXAMPLE 11-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 nm was spin-coated on the ARC layer, and then baked at 110° C. for 60 seconds, thus forming a photoresist layer with a thickness of about 1800 Å.

The top coating composition according to the example 11-1 was spin-coated onto the wafer to form a layer of a uniform thickness, and was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 140 nm were obtained.

### EXAMPLE 11-3

### Comparison Example: Barrier Characteristics in Immersion Lithography Process using Top Coating Layer when TAG was Omitted in Example 11-2

Except for the use of an isopropanol solution in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:4 was dissolved as the top coating composition, other elements were the same as in the example 11-2. As a result, line and space patterns with a pitch of about 140 nm which show a serous T-top profile were obtained.

### EXAMPLE 12

### EXAMPLE 12-1

### Manufacture of Top Coating Composition for Immersion Lithography Process

50 mg of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:2 and 2.5 mg of TAG (KUMHO TAG lot#020114 obtained from KUMHO ASAN Lab.) were dissolved in 4.95 g of an isopropanol solution, and then the solution was filtrated to obtain a top coating composition.

### EXAMPLE 12-2

### Barrier Characteristics in Immersion Lithography Process using Top Coating Layer

An anti-reflective coating (ARC) material (ARC 26A™ manufactured by Nissan Chemical Industry) used for an exposure wavelength of 193 nm was spin-coated on an 8-inch bare silicon wafer, and then baked to form an ARC layer with a thickness of about 300 Å. Then, a photoresist (TARF 6111™ manufactured by Tokyo Oka Industry Co. Ltd.) used for an exposure wavelength of 193 run was spin-coated on the ARC layer, and then baked at 110° C. for 60 seconds, thus forming a photoresist layer with a thickness of about 1800 Å.

The top coating composition according to the example 11-1 was spin-coated onto the wafer to form a layer of a uniform thickness, and was heat-treated at about 100° C. for about 90 seconds to form a top coating layer. The result was soaked in deionized water, exposed to an ArF excimer laser, soaked in deionized water for 60 seconds, subjected to PEB at 120° C. for 60 seconds, and then developed with a 2.38% tetramethylammonium hydroxide solution. As a result, fine line and space patterns with a pitch of about 140 nm were obtained.

### EXAMPLE 12-3

### Comparison Example: Barrier Characteristics in Immersion Lithography Process using Top Coating Layer when TAG was Omitted in Example 12-2

Except for an isopropanol solution in which an 1% by weight of poly(2-ethyl-2-adamantyl acrylate-co-3-hydroxypropyl acrylate) obtained by mixing and polymerizing 2-ethyl-2-adamantyl acrylate and 3-hydroxypropyl acrylate with a mole ratio of 3:2 was dissolved as the top coating composition, other elements were the same as in the example 12-2. As a result, line and space patterns with a pitch of about 140 nm were not obtained.

### EXAMPLE 13

### Solubility of Polymer in Top Coating Composition

Polymers differently including various functional monomer units were made. The solubilities of the polymers to deionized water and to a developing solution of 2.38% by weight of tetramethylammonium hydroxide solution were measured. The results are shown in Table 1.

TABLE 1

| | COMPONENT | | | | |
|---|---|---|---|---|---|
| POLYMER | MOLE | | | SOLUBILITY | |
| STRUCTURE | RATIO OF | | | DEION- | DEVEL- |
| (N:A:P MOLE | POLYMER | | | IZED | OPING |
| RATIO) | A/N | P/N | C.A. (°) | WATER | SOLUTION |
| POLYMER A | 0.75 | 0 | 81 | ◯ | ◯ |
| (8:6:0) | | | | | |
| POLYMER B | 0.63 | 0.38 | 80 | ◯ | ◯ |
| (8:5:3) | | | | | |
| POLYMER C | 0.38 | 0.63 | 78 | ◯ | Δ |
| (8:3:5) | | | | | |
| POLYMER D | 0.13 | 1 | 75 | ◯ | X |
| (8:1:8) | | | | | |
| POLYMER E | 0.25 | 2.3 | — | Δ | Δ |
| (4:1:9) | | | | | |
| POLYMER F | 0 | 2 | 72 | Δ | X |
| (3:0:6) | | | | | |
| POLYMER G | 0 | 1.3 | 80 | ◯ | XX |
| (3:0:4) | | | | | |

In Table 1, N, A, and P are monomer units used to polymerized polymers. N indicates 2-ethyl-2-adamantyl-acrylate, A indicates acrylic acid, and P indicates 3-hydroxy-propyl-acrylate. “C.A.” indicates a contact angle with respect to water.

Each of the polymers A through G was dissolved in an alcoholic organic solvent by the methods described in the examples 1 though 12 and filtrated though a PTFE membrane filter of 0.2 μm, and thus each of a top coating composition was obtained. By the same methods described in the examples 1 though 12, a top coating layer was formed on a bare-silicon wafer using each of the top coating composition. Then, C.A., the solubility to the deionized water, and the solubility to the developing solution of each of the top coating layers were evaluated. To evaluate the solubility of to the deionized water, deionized water was supplied at 700 to 1000 rpm to each of the top coating layer to rinse it.

As shown in Table 1, the amount of the acid group, that is, the amount of the monomer unit A, affects insignificantly the solubility of the polymer to the deionized water, but significantly affects the solubility of the polymer to the developing solution. Meanwhile, the amount of the polar group, that is, the amount of the monomer unit P, affects insignificantly the solubility of the polymer both to the deionized water and to the developing solution unless a large amount was used, for example, in the polymers E and F. When the polar group was not included like the polymer A, the solubility to the alcoholic organic solvent was inferior, and thus the making of the top coating composition was difficult.

### EXAMPLE 14

### Immersion Lithography Performance for Forming a Line and Space Pattern

Line and space patterns with a width of 90 nm was formed with respect to the polymer C and the polymer F in Table 1, and then the immersion lithography performances of the polymer C and the polymer F were evaluated.

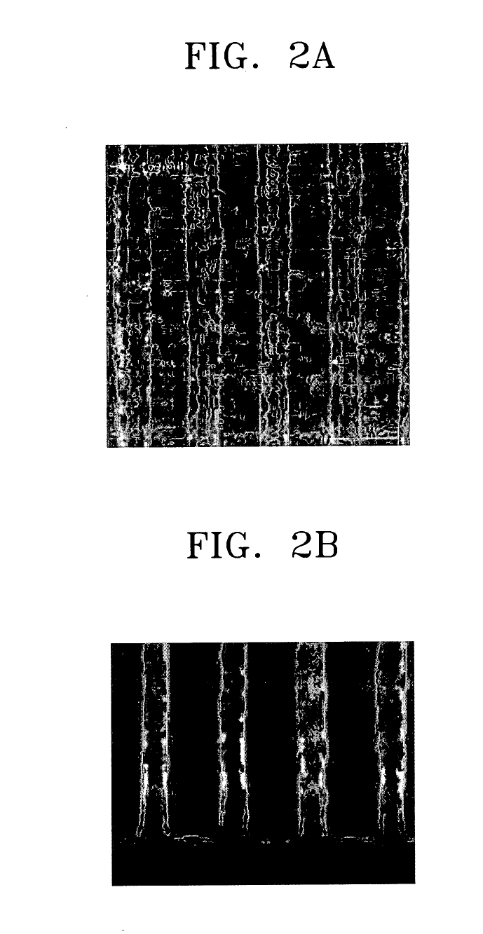

FIG. 2A is a scanning electron microscopy (SEM) image showing a top profile of a line and space pattern obtained by the immersion lithography of the example 8 using the polymer C in Table 1 according to an embodiment of the present invention. FIG. 2B is a SEM image showing a vertical profile of the line and space pattern of FIG. 2A.

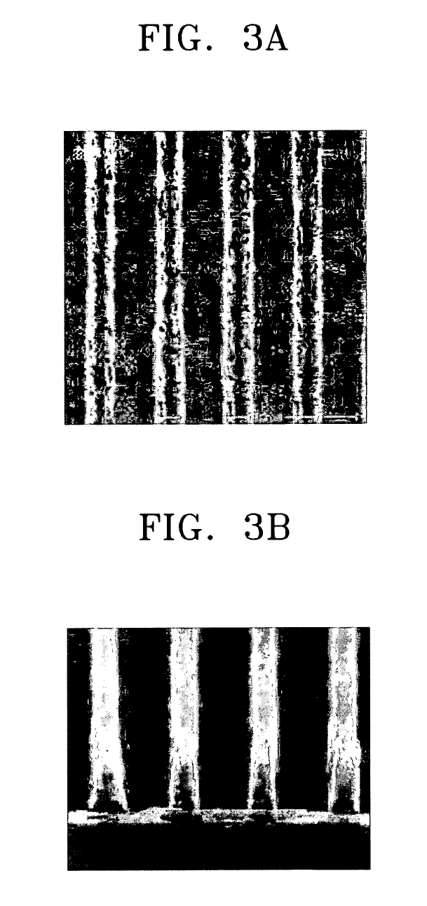

FIG. 3A is a SEM image showing a top profile of a line and space pattern obtained by the immersion lithography of the example 6 using the polymer F in Table 1 according to an embodiment of the present invention. FIG. 3B is a SEM image showing a vertical profile of the line and space pattern of FIG. 3A.

Referring to FIGS. 3A and 3B, in the case of the polymer F where an acid group, that is the monomer unit A, was not included, good top and vertical profiles were obtained.

### EXAMPLE 15

### Effect of TAG

A line and space pattern with a width of 70 nm as a pattern having a lower design rule was formed with respect to the polymer G in Table 1, and then the immersion lithography performance of the polymer G was evaluated.

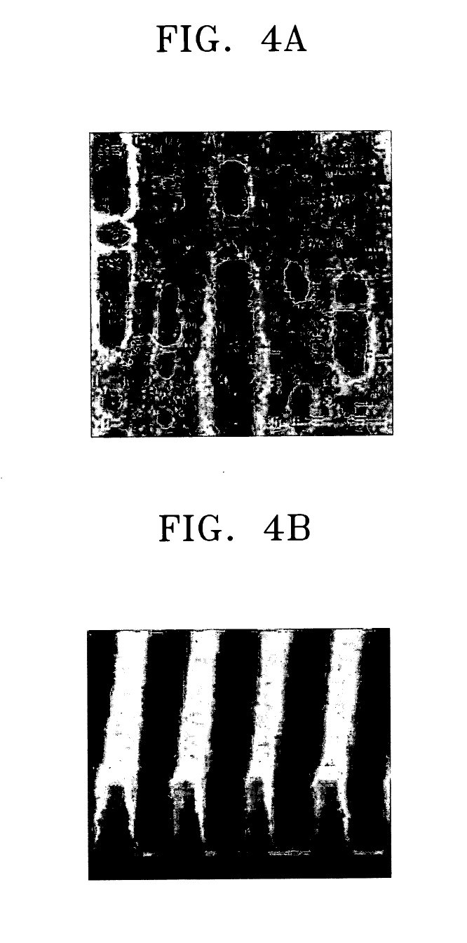

FIG. 4A is a SEM image showing a top profile of a line and space pattern obtained by the immersion lithography of the example 11-3 using the polymer G in Table 1 according to an embodiment of the present invention. FIG. 4B is a SEM image showing a vertical profile of the line and space pattern of FIG. 4A. In FIGS. 4A and 4B, TAG was not included in the top coating composition obtained from the polymer G.

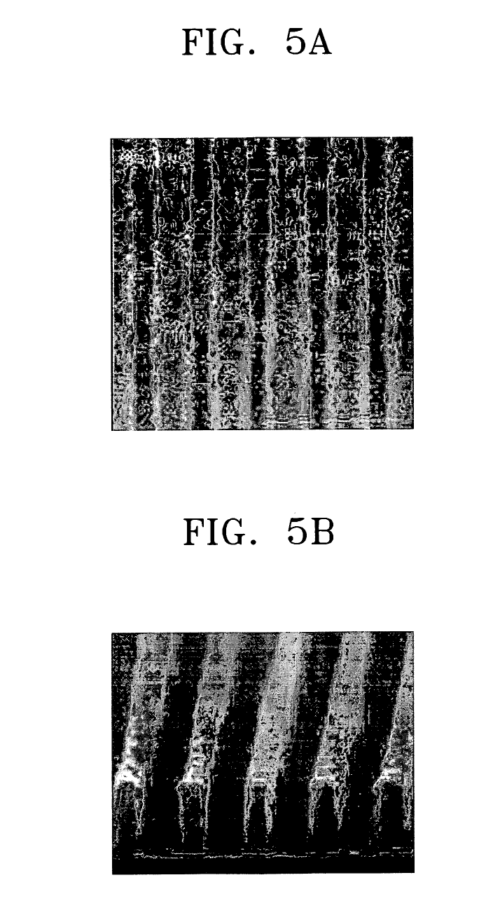

FIG. 5A is a SEM image showing a top profile of a line and space pattern obtained by the immersion lithography of the example 11-2 using the polymer G in Table 1 according to an embodiment of the present invention. FIG. 5B is a SEM image showing a vertical profile of the line and space pattern of FIG. 5A. In FIGS. 5A and 5B, TAG was included in the top coating composition obtained from the polymer G.

Referring to FIGS. 4A through 5B, when a fine line and space pattern having a smaller design rule is formed, in the case of the polymer G not having the acid group, that is the monomer unit A, the solubility to the developing solution is inferior, and thus, it is impossible to obtain a desired pattern. Otherwise, when TAG is added to the polymer G, TAG increases the solubility to the developing solution, thereby obtaining a fine top profile and good vertical profile.

The top coating composition according to an embodiment of the present invention includes a polymer including at least three different structural repeating units, which are a first repeating unit having a carboxy group substituted by an alkyl protecting group or an acid-labile group, a second repeating unit having an acid group, and a third repeating unit having a polar group; and an alcoholic organic solvent.

According to an embodiment of the present invention, a water-insoluble top coating layer obtained from a composition having an alcoholic organic solvent is used as a barrier during immersion lithography such that photoresist components are prevented from dissolving in the liquid medium during exposure through the liquid medium and from the intermixing with the photoresist during photolithography. In addition, according to an embodiment of the present invention, the top coating composition can be formed into a top coating barrier which has low absorbance to an exposure light source during exposure, and is easily soluble in a developing solution after exposure in an immersion lithography process. A photoresist pattern is formed using the top coating composition according to an embodiment of the present invention in immersion lithography, thereby obtaining a pattern which can provide enhanced resolution and depth of focus (DOF).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A top coating composition comprising:
a polymer including at least three different structural repeating units including a first repeating unit comprising a carboxy group substituted by an alkyl protecting group or an acid-labile group, a second repeating unit comprising an acid group, and a third repeating unit comprising a polar group; and
an organic solvent comprising an alcohol.

2. The top coating composition of claim 1, wherein the first repeating unit comprises the following structural formula: 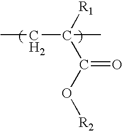
where R₁ is hydrogen, fluorine, methyl, or trifluoromethyl; and R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl.

3. The top coating composition of claim 1, wherein the acid group in the second repeating unit is a carboxy group or a sulfonic group.

4. The top coating composition of claim 3, wherein the second repeating unit is a monomer unit selected from the group consisting of acrylate, methacrylate, α-fluoroacrylate, trifluoromethyl acrylate, vinyl sulfonic acid, styrene sulfonic acid, maleate, and crotonic acid.

5. The top coating composition of claim 1, wherein the polar group in the third repeating unit is an acid group or an alcohol group.

6. The top coating composition of claim 1, wherein the third repeating unit is 2-hydroxyethyl acrylate, 2-hydroxyethyl methacrylate, 3-hydroxypropyl acrylate, 2-hydroxypropyl acrylate, 3-hydroxypropyl methacrylate, 2-hydroxypropyl methacrylate, 2-hydroxyethyl α-fluoroacrylate, 2-hydroxyethyl trifluoromethylacrylate, 3-hydroxypropyl α-fluoroacrylate, 2-hydroxypropyl α-fluoroacrylate, 3-hydroxypropyl trifluoromethylacrylate, 2-hydroxypropyl trifluoromethylacrylate, α,α-bis-(trifluorometyl)-bicyclo[2.2.1]hept-5-ene-ethanol, 5-[1′,1′,1′-trifluoro-2′-trifluorometyl-2′-hydroxy)propyl]norbornan-2-yl vinyl ether, 6-[3,3,3-trifluoro-2-hydroxy-2-trifluoromethylpropyl]bicyclo[2.2.1]hept-2-yl 2-trifluoromethylacrylate, 3,5-bis(hexafluoro-2-hydroxy-2-propyl)cyclohexyl 2-trifluoromethylacrylate, or 3,5-bis(hexafluoro-2-hydroxy-2-propyl)cyclohexyl vinyl ether.

7. The top coating composition of claim 1, wherein the polymer further includes a fourth repeating unit comprising fluorine.

8. The top coating composition of claim 7, wherein the fourth repeating unit is tetrafluoroethylene, α,α,α-trifluroethyl acrylic acid, α,α,α-trifluroethyl methacrylic acid, α,α,α-trifluroethyl α-fluoroacrylic acid, or α,α,α-trifluroethyl trifluoromethylacrylic acid.

9. The top coating composition of claim 7, wherein the fourth repeating unit further comprises a polar group.

10. The top coating composition of claim 9, wherein the fourth repeating unit comprises the following structural formula: 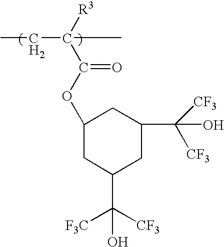
where R₃ is hydrogen or a methyl group.

11. The top coating composition of claim 1, wherein the polymer comprises the following structural formula: 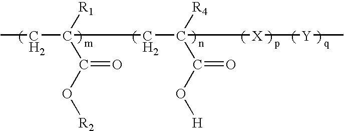
where m+n+p+q=1; 0.03≦m/(m+n+p+q)≦0.97; 0.03≦(n+p)/(m+n+p+q)≦0.97; 0≦q/(m+n+p+q)≦0.5; R₁ is hydrogen, fluorine, methyl, or trifluoromethyl; R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl; R₄ is hydrogen, fluorine, methyl, or trifluoromethyl; X is a polar group; and Y is a monomer unit selected from the group consisting of a vinyl type monomer, an alkylene glycol type monomer, an anhydrous maleate monomer, an ethyleneimine monomer, a monomer including an oxazoline group, an acrylonitirle monomer, an allyl amide monomer, a 3,4-dihydropyran monomer, a 2,3-dihydrofuran monomer, a tetrafluoroethylene monomer, an α,α,α-trifluroethyl acrylic acid monomer, an α,α,α-trifluroethyl methacrylic acid monomer, an α,α,α-trifluroethyl α-fluoroacrylic acid monomer, and an α,α,α-trifluroethyl trifluoromethylacrylic acid monomer.

12. The top coating composition of claim 1, wherein the polymer comprises a weight average molecular weight (Mw) of from about 1,000 up to 100,000 daltons.

13. The top coating composition of claim 1, wherein the amount of the polymer is from about 0.1 up to 5.0% by weight, based on the total weight of the top coating composition.

14. The top coating composition of claim 1, wherein the organic solvent is selected from the group consisting of ethanol, n-propylalcohol, isopropyl alcohol, 1-methoxy-2-propanol, n-butanol, 2-butanol, 3-methyl-2-butanol, n-pentanol, 2-pentanol, 3-methyl-2-pentanol, and 4-methyl-2-pentanol, or a combination thereof.

15. The top coating composition of claim 1, further comprising a thermal acid generator (TAG).

16. The top coating composition of claim 15, wherein the amount of the TAG is from about 0.05 up to 0.3% by weight, based on the total weight of the top coating composition.

17. The top coating composition of claim 1, further comprising a surfactant.

18. The top coating composition of claim 17, wherein the amount of the surfactant is from about 0.001 up to 0.01% by weight, based on the total weight of the top coating composition.

19. The top coating composition of claim 1, further comprising a fluorinated compound.

20. The top coating composition of claim 19, wherein the fluorinated compound is at least one of tetramethylammonium trifluoroacetate, tetramethylammonium pentafluoropropionate, tetramethylammonium heptafluorobutyrate, tetramethylammonium nonafluorovalerate, tetramethylammonium undecafluorohexanate, tetramethylammonium tridecafluoroheptanate, tetramethylammonium pentadecafluorooctanate, tetramethylammonium heptadecafluorononanate, tetramethylammonium nonadecafluorodecanate, tetramethylammonium perfluoroundecanate, tetramethylammonium tricosafluorododecanate, tetramethylammonium perfluorotetradecanate, tetramethylammonium heptadecafluorooctanesulfonate, and tetramethylammonium nonafluorobutane-1-sulfonate.

21. The top coating composition of claim 19, wherein the amount of the fluorinated compound is from about 0.01 up to 0.3% by weight based on the total weight of the top coating composition.

22. A method of forming a photoresist pattern, comprising:
forming a photoresist layer on a substrate;
soft-baking the photoresist layer at a first temperature;
forming a top coating layer on the soft-baked photoresist layer, the top coating layer comprising an organic solvent comprising an alcohol and a polymer including at least three different structural repeating units that include a first repeating unit comprising a carboxy group substituted by one of an alkyl protecting group and an acid-labile group, a second repeating unit comprising an acid group, and a third repeating unit comprising a polar group;
exposing a predetermined region of the photoresist layer through the liquid medium when the top coating layer covers the photoresist layer;
post-exposure baking (PEB) the exposed photoresist layer;
removing the top coating layer; and
developing the exposed photoresist layer.

23. The method of claim 22, wherein the forming of the top coating layer comprises:
spin-coating a top coating composition on the photoresist layer; and
heat-treating the spin-coated top coating composition.

24. The method of claim 23, wherein the spin-coating is performed at from about 500 up to 3000 rpm for from about 30 up to 90 seconds.

25. The method of claim 23, wherein the heat treatment is performed at a temperature between of from about 95 up to 105° C.

26. The method of claim 22, wherein the removing of the top coating layer and the developing of the exposed photoresist layer are performed at the same time.

27. The method of claim 26, wherein an alkaline developing solution is used for the removing of the top coating layer and for developing of the exposed photoresist layer.

28. The method of claim 22, wherein, in the exposing of the predetermined region in the photoresist layer, a light source selected from a KrF excimer laser, an ArF excimer laser, and a F₂ excimer laser is used.

29. The method of claim 22, wherein the photoresist layer comprises a positive resist composition or a negative resist composition.

30. The method of claim 22, wherein the first repeating unit comprises the following structural formula: 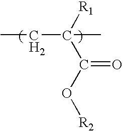
where R₁ is hydrogen, fluorine, methyl, or trifluoromethyl; R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl.

31. The method of claim 22, wherein an acid group in the second repeating unit is a carboxy group or a sulfonic group.

32. The method of claim 31, wherein the second repeating unit is a monomer unit selected from the group consisting of acrylate, methacrylate, α-fluoroacrylate, trifluoromethyl acrylate, vinyl sulfonic acid, styrene sulfonic acid, maleate, and crotonic acid.

33. The method of claim 22, wherein a polar group in the third repeating unit is an acid group or an alcohol group.

34. The method of claim 22, wherein the third repeating unit is 2-hydroxyethyl acrylate, 2-hydroxyethyl methacrylate, 3-hydroxypropyl acrylate, 2-hydroxypropyl acrylate, 3-hydroxypropyl methacrylate, 2-hydroxypropyl methacrylate, 2-hydroxyethyl α-fluoroacrylate, 2-hydroxyethyl trifluoromethylacrylate, 3-hydroxypropyl α-fluoroacrylate, 2-hydroxypropyl α-fluoroacrylate, 3-hydroxypropyl trifluoromethylacrylate, 2-hydroxypropyl trifluoromethylacrylate, α,α-bis-(trifluorometyl)-bicyclo[2.2.1]hept-5-ene-ethanol, 5-[1′,1′,1′-trifluoro-2′-trifluorometyl-2′-hydroxy]propyl]norbornan-2-yl vinyl ether, 6-[3,3,3-trifluoro-2-hydroxy-2-trifluoromethylpropyl]bicyclo[2.2.1]hept-2-yl 2-trifluoromethylacrylate, 3,5-bis(hexafluoro-2-hydroxy-2-propyl)cyclohexyl 2-trifluoromethylacrylate, or 3,5-bis(hexafluoro-2-hydroxy-2-propyl)cyclohexyl vinyl ether.

35. The method of claim 22, wherein the polymer further includes a fourth repeating unit comprising fluorine.

36. The method of claim 35, wherein the fourth repeating unit is tetrafluoroethylene, α,α,α-trifluroethyl acrylic acid, α,α,α-trifluroethyl methacrylic acid, α,α,α-trifluroethyl α-fluoroacrylic acid, or α,α,α-trifluroethyl trifluoromethylacrylic acid.

37. The method of claim 35, wherein the fourth repeating unit further comprises a polar group.

38. The method of claim 37, wherein the fourth repeating unit comprises the following structural formula: 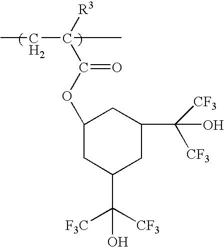
where R₃ is hydrogen or a methyl group.

39. The method of claim 22, wherein the polymer comprises the following structural formula: 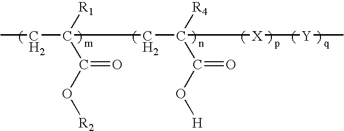
where m+n+p+q=1; 0.03≦m/(m+n+p+q)≦0.97; 0.03≦(n+p) (m+n+p+q)≦0.97; 0≦q/(m+n+p+q)≦0.5; R₁ is hydrogen, fluorine, methyl, or trifluoromethyl; R₂ is a C₁ to C₁₀ alkyl group, t-butyl, isonorbornyl, 2-methyl-2-adamantyl, 2-ethyl-2-adamantyl, 3-tetrahydrofuranyl, 3-oxocyclohexyl, γ-butyrolactone-3-yl, mevaloniclactone, γ-butyrolactone-2-yl, 3-methyl-γ-butyrolactone-3-yl, 2-tetrahydropyranyl, 2-tetrahydrofuranyl, 2,3-propylenecarbonate-1-yl, 1-methoxyethyl, 1-ethoxyethyl, 1-(2-methoxyethoxy)ethyl, 1-(2-acetoxyethoxy)ethyl, t-butoxycarbonylmethyl, methoxymethyl, or ethoxymethyl; R₄ is hydrogen, fluorine, methyl, or trifluoromethyl; X is a polar group; and Y is a monomer unit selected from the group consisting of a vinyl type monomer, an alkylene glycol type monomer, an anhydrous maleate monomer, an ethyleneimine monomer, a monomer including an oxazoline group, an acrylonitirle monomer, an allyl amide monomer, a 3,4-dihydropyran monomer, a 2,3-dihydrofuran monomer, a tetrafluoroethylene monomer, an α,α,α-trifluroethyl acrylic acid monomer, an α,α,α-trifluroethyl methacrylic acid monomer, an α,α,α-trifluroethyl α-fluoroacrylic acid monomer, and an α,α,α-trifluroethyl trifluoromethylacrylic acid monomer.

40. The method of claim 22, wherein the polymer comprises a weight average molecular weight (Mw) of from about 1,000 up to 100,000 daltons.

41. The method of claim 22, wherein the amount of the polymer is from about 0.1 up to 5.0% by weight, based on the total weight of the top coating composition.

42. The method of claim 22, wherein the organic solvent is ethanol, n-propylalcohol, isopropyl alcohol, 1-methoxy-2-propanol, n-butanol, 2-butanol, 3-methyl-2-butanol, n-pentanol, 2-pentanol, 3-methyl-2-pentanol, or 4-methyl-2-pentanol, or a combination thereof.

43. The method of claim 22, wherein the top coating layer further comprises a thermal acid generator.

44. The method of claim 43, wherein the amount of the thermal acid generator is from about 0.05 up to 0.3% by weight, based on the total weight of the top coating composition.

45. The method of claim 22, wherein the top coating layer further comprises a surfactant.

46. The method of claim 45, wherein the amount of the surfactant is from about 0.001 up to 0.01% by weight, based on the total weight of the top coating composition.

47. The method of claim 22, wherein the top coating layer further comprises a fluorinated compound.

48. The method of claim 47, wherein the fluorinated compound is tetramethylammonium trifluoroacetate, tetramethylammonium pentafluoropropionate, tetramethylammonium heptafluorobutyrate, tetramethylammonium nonafluorovalerate, tetramethylammonium undecafluorohexanate, tetramethylammonium tridecafluoroheptanate, tetramethylammonium pentadecafluorooctanate, tetramethylammonium heptadecafluorononanate, tetramethylammonium nonadecafluorodecanate, tetramethylammonium perfluoroundecanate, tetramethylammonium tricosafluorododecanate, tetramethylammonium perfluorotetradecanate, tetramethylammonium heptadecafluorooctanesulfonate, or tetramethylammonium nonafluorobutane-1-sulfonate.

49. The method of claim 47, wherein the amount of the fluorinated compound is from about 0.01 up to 0.3% by weight, based on the total weight of the top coating composition.
